(19) United States
(12) Patent Application Publication
(10) Pub. No.: US 2021/0060703 A1
(43) Pub. Date: Mar. 4, 2021

(54) DEVICE AND METHOD FOR FORMING CERAMIC-REINFORCED METAL MATRIX COMPOSITE BY FOLLOW-UP ULTRASONIC-ASSISTED DIRECT LASER DEPOSITION

(71) Applicant: Dalian University of Technology, Dalian City (CN)

(72) Inventors: Guangyi MA, Dalian City (CN); Yang LI, Dalian City (CN); Dongjiang WU, Dalian City (CN); Fangyong NIU, Dalian City (CN); Chao YU, Dalian City (CN)

(21) Appl. No.: 16/857,375

(22) Filed: Apr. 24, 2020

(30) Foreign Application Priority Data
Sep. 3, 2019 (CN) 201910826372.2

(51) Int. Cl. B23K 26/342; B33Y 10/00; B33Y 30/00; B23K 26/00; B23K 26/082; B23K 26/12; B23K 26/06; B23K 26/14; B23K 26/70

(52) U.S. Cl. CPC B23K 26/342; B33Y 10/00; B33Y 30/00; B23K 26/0093; B23K 26/082; B33Y 50/00; B23K 26/127; B23K 26/0626; B23K 26/1464; B23K 26/703; B23K 26/123

(57) ABSTRACT

The present invention provides a device and method for forming a ceramic-reinforced metal matrix composite (MMC) by follow-up ultrasonic-assisted direct laser deposition (DLD), and belongs to the technical field of additive manufacturing (AM). A positioning and clamping device is used to keep an ultrasonic impact gun to follow a coaxial powder feeding nozzle. During the DLD process of the ceramic-reinforced MMC, the cavitation, acoustic flow and mechanical and thermal effects of an ultrasound are used to intervene in a solidification behavior of a molten pool in real time, and a localized strengthening effect of an ultrasonic impact is used to adjust a stress in real time. Compared with a DLD forming method without follow-up ultrasound application, the method of the present invention effectively reduces the voids inside a workpiece, and ensures the consistency of a solidified structure and the evenness of stress distribution.

### TECHNICAL FIELD

The present invention belongs to the technical field of additive manufacturing (AM), and relates to a device and method for forming a ceramic-reinforced metal matrix composite (MMC) by follow-up ultrasonic-assisted direct laser deposition (DLD).

### BACKGROUND

DLD combines digital manufacturing technology and laser technology. It uses high-energy-density laser heat sources to directly melt high-melting ceramic and metal powders, and can rapidly form parts after in-situ deposition of the molten powder. Compared with conventional manufacturing technologies, DLD has the advantages of high material utilization, wide range of applicable materials and strong system flexibility, etc. DLD has been widely used in aviation, aerospace, nuclear power equipment, biomedical and other fields. However, research shows that the distribution of the structure is uneven due to the unsteady solidification behavior and the distribution of the stress is uneven due to the fast-melting and fast-solidifying characteristics. Consequently, the residual stress is large, making the ceramic-reinforced metal matrix composite (MMC) obtained by DLD unable to meet the harsh operating requirements. Therefore, it is necessary to ensure the consistency of the solidified structure and the evenness of the stress distribution in the DLD.

The methods for solving such problems as coarse grains and uneven structure distribution during the melting and solidifying process include substrate preheating method, magnetic-field-assisted method, arc composite method and ultrasonic-assisted method, etc. Among them, the ultrasonic-assisted method uses the cavitation, acoustic flow and mechanical and thermal effects of ultrasound to effectively intervene in the solidification behavior of the molten pool. This is conducive to refine grains and make the structure distribution even. However, the ultrasonic-assisted method uses an ultrasonic vibration plate at the bottom to drive the workpiece to generate ultrasonic vibration. Such an application method of ultrasonic energy field has low ultrasonic energy utilization, limited improvement on stress, and cannot achieve effective ultrasound intervention in the entire area of large components. The methods used to solve the problems of uneven stress distribution and large residual stress include shot peening, mechanical grinding, laser impact and ultrasonic impact, etc. Among them, the ultrasonic impact method uses the high-speed impact of the impact needle on the surface of the part to produce a compressive stress layer on the surface of the part, thereby improving the stress distribution and mechanical properties. The ultrasonic impact method is performed after the cladding layer is deposited. Although this method can refine the grains, it does not intervene in the solidification behavior of the molten pool, and thus has limited improvement on the consistency of the structure distribution. In addition, it is complicated to operate, and requires repeated opening and closing of the ultrasonic impact system and the DLD system. Related reports are as follows:

Chinese patent CN 201610390878.X discloses a method for forming an Al₂O₃-based eutectic ceramic tool by an ultrasonic-assisted laser near-net-shape (NNS) process. The ultrasonic vibration plate is placed on a workbench. During the laser NNS forming of the Al₂O₃ eutectic ceramic tool, the pre-adjustment of the ultrasonic device and the real-time change of the auxiliary ultrasonic power achieve the equivalent effect of ultrasound on the molten pool. This method can refine the grains and promote the evenness of element distribution. But the method uses an ultrasonic vibration plate at the bottom to drive the workpiece to generate ultrasonic vibration, which has low ultrasonic energy utilization, limited improvement on stress, and poor adaptability in the preparation of large components.

Chinese patent CN201310214376.8 discloses a device and method for strengthening a laser cladding layer by an ultrasonic impact. The ultrasonic impact is applied to the laser cladding layer after single-course laser cladding is completed, and alternately performed with laser cladding during multi-course multi-layer laser cladding. The ultrasonic impact forms a plastic deformation layer with a certain depth on the surface of the laser cladding layer. Meanwhile, a compressive stress is implanted to eliminate the residual stress in the laser cladding layer to a certain extent. However, this device and method do not participate in the solidification behavior of the molten pool, and thus have limited improvement on the consistency of the structure. In addition, this device and method are complicated to operate, and require repeated opening and closing of the ultrasonic impact system and the DLD system.

### SUMMARY

The present invention provides a device and method for forming a ceramic-reinforced metal matrix composite (MMC) by follow-up ultrasonic-assisted direct laser deposition (DLD). The present invention solves the problems of inconsistent structure distribution and uneven stress distribution in the DLD process of a ceramic-reinforced MMC. A positioning and clamping device is used to keep an ultrasonic impact gun to follow a coaxial powder feeding nozzle. During the DLD process of the ceramic-reinforced MMC, a solidification behavior of a molten pool is intervened in real time by an ultrasonic effect, and a stress is regulated in real time by an ultrasonic impact. In this way, grain refinement is promoted, and the consistency of structure distribution and the evenness of the stress are guaranteed. The follow-up ultrasound application method has high ultrasonic energy utilization, and realizes ultrasound intervention in the forming process of a large component.

### The Present Invention Adopts the Following Technical Solutions

A device for forming a ceramic-reinforced MMC by follow-up ultrasonic-assisted DLD, including a coaxial powder feeding type laser melt deposition (LMD) forming system, a positioning and clamping device for keeping an ultrasonic impact gun to follow a coaxial powder feeding nozzle, and a follow-up ultrasound system.

The coaxial powder feeding type LMD forming system includes a laser 1, a powder feeder 2, a powder feeding cylinder 3, an industrial personal computer (IPC) 6, a coaxial powder feeding nozzle 16, a metal substrate 18, a computer numerical control (CNC) machine tool 20, a cooling water circulation system 7 and a protective gas system 4. The CNC machine tool 20 is provided with a dovetail-shaped guide rail 15 and a computer numerical control (CNC) workbench 19. The metal substrate 18 is placed on an upper surface of the CNC workbench 19. The coaxial powder feeding nozzle 16 is fixed on the dovetail-shaped guide rail 15. The laser 1 is provided with an optical path system. Laser light emitted by the laser 1 is emitted from the coaxial powder feeding nozzle 16 through the optical path system to form a laser beam on the metal substrate 18. Two powder feeding cylinders 3 are connected above the powder feeder 2 to provide a ceramic powder and a metal powder for the coaxial powder feeding type LMD forming system. The powder feeder 2 is connected to the coaxial powder feeding nozzle 16. A powder sprayed from the axial powder feeding nozzle 16 is converged on the metal substrate 18 and overlaps with the laser beam to form a deposited layer 17. The protective gas system (inert gas) 4 is connected to the powder feeder 2 on one side, and serves as a carrier gas to blow a cladding powder from the powder feeder 2 into a molten pool. The protective gas system 4 is connected to the coaxial powder feeding nozzle 16 on the other side, and serves as a coaxial protective gas. The cooling water circulation system 7 is connected to the coaxial powder feeding nozzle 16 for cooling a laser head on the coaxial powder feeding nozzle 16. The IPC 6 is connected to the laser 1, the powder feeder 2 and the CNC machine tool 20, and is used to control the laser 1, the powder feeder 2 and the CNC machine tool 20.

The positioning and clamping device includes an F-shaped positioning base 8, a T-shaped manual precision slide table 12 and an ultrasonic impact gun holder 11. The T-shaped manual precision slide table 12 is fixed on the F-shaped positioning base 8, and the F-shaped positioning base 8 is fixed on one side of the dovetail-shaped guide rail 15. The ultrasonic impact gun holder 11 is connected to the T-shaped manual precision slide table 12, and the ultrasonic impact gun holder 11 is used to fixedly connect the ultrasonic impact gun.

The follow-up ultrasound system includes an ultrasonic generator 5 and the ultrasonic impact gun connected to the ultrasonic generator 5. The ultrasonic impact gun is fixed on the ultrasonic impact gun holder 11 and located directly behind the coaxial powder feeding nozzle 16, so that the ultrasonic impact gun follows the coaxial powder feeding nozzle 16. The ultrasonic impact gun includes a transducer 9, a horn 10, a tool head 13 and an ultrasonic impact needle 14 which are connected in order.

Further, an adjustable angle between an axis of the ultrasonic impact gun and an axis of the coaxial powder feeding nozzle 16 is 15°-45°. A vertical distance between the coaxial powder feeding nozzle 16 and the metal substrate 18 is 5-10 mm, a vertical distance between the ultrasonic impact needle 14 and the metal substrate 18 is 5-10 mm, and a horizontal distance between the ultrasonic impact needle 14 and the coaxial powder feeding nozzle 16 is 5-50 mm.

Further, the metal substrate 18 is made of titanium, a titanium alloy, iron, an iron alloy, nickel, a nickel alloy, cobalt and a cobalt alloy, etc.

Further, the protective gas system 4 is an inert gas.

A method for forming a ceramic-reinforced MMC by follow-up ultrasonic-assisted DLD, including the following steps:

(1) Drying a cladding powder; grinding, cleaning and drying a metal substrate 18; putting the cladding powder into two powder feeding cylinders 3 of a powder feeder 2, respectively.

The cladding powder includes a ceramic powder and a metal powder; the ceramic powder includes a carbide (TiC, SiC), an oxide, a boride and a nitride, etc; the metal powder includes titanium, a titanium alloy, iron, an iron alloy, nickel, a nickel alloy, cobalt and a cobalt alloy, etc.

The process of drying the cladding powder is as follows: drying the cladding powder at 100-150° C. for 4-6 h, and then naturally cooling.

(2) Fixedly connecting an ultrasonic impact gun through an ultrasonic impact gun holder 11, a T-shaped manual precision slide table 12 and an F-shaped positioning base 8 to a Y-axis dovetail-shaped guide rail 15 of a CNC machine tool 20, so that the ultrasonic impact gun follows a coaxial powder feeding nozzle 16; positioning the ultrasonic impact gun directly behind the coaxial powder feeding nozzle 16, keeping a horizontal distance between an ultrasonic impact needle 14 and the coaxial powder feeding nozzle 16 within a maximum plastic deformation range (5-50 mm) of a cladding layer, and adjusting a vertical distance between the coaxial powder feeding nozzle 16 and a metal substrate 18 to allow a powder convergence point of the coaxial powder feeding nozzle 16 on the metal substrate 18; adjusting a vertical distance between the ultrasonic impact gun and the metal substrate 18 to ensure that the ultrasonic impact needle 14 effectively acts on a deposited layer 17.

(3) Starting an ultrasonic generator 5 so that the ultrasonic impact gun is in an ultrasonic vibration state, where the ultrasonic generator 5 has an ultrasonic power of 500-2000 w and an ultrasonic frequency of 15-25 kHz.

(4) Starting a cooling water circulation system 7, a laser 1, a protective gas system 4 and a powder feeder 2 in order, where the laser 1 has a laser power of 200-2000 W and a scanning speed of 100-1000 mm/min; a Z axis of the machine tool is lifted for 0.1-1.0 mm after each layer of deposition; the powder feeder 2 has a powder feed rate of 10-50 r/min.

(5) Starting the CNC machine tool 20, and controlling the coaxial powder feeding nozzle 16 to move relative to the metal substrate 18 on a CNC workbench 19 to deposit a first layer of material, where at this time, the ultrasonic impact needle 14 acts 50-250 μm under a deposited layer 17, so as to ensure that the ultrasonic impact gun always acts on the deposited layer 17 to intervene in a melting process in real time and implement the regulation of a stress state, where each time a formed height is increased by 2-6 mm in a lifting direction of the Z axis, the ultrasonic power of the ultrasonic generator 5 is increased by 100-200 W.

The intervention in the melting process is related to an amplitude A near a molten pool. The amplitude A near the molten pool has a linear relationship with the ultrasonic power P, that is, A=0.0055 P+3, where the unit of the amplitude A is μm and the unit of the ultrasonic power P is W; the amplitude A near the molten pool is also related to a position B below the deposited layer 17 where the ultrasonic impact needle 14 acts, and the two have a linear relationship, that is, A=0.165 B−1.25, and the unit of the position B is μm.

(6) Shutting down the powder feeder 2, the protective gas system 4, the laser 1, the cooling water circulation system 7 and the CNC machine tool 20 in order after the formation is completed; gradually reducing the ultrasonic power of the ultrasonic generator 5 at the speed of 100-200 W/min to zero, and shutting down the ultrasonic generator 5.

The Present Invention has the Following Beneficial Effects:

(1) The present invention intervenes in the melting process in real time through the cavitation, acoustic flow and mechanical and thermal effects of the ultrasonic impact process. The present invention controls the solidified structure to be formed with multiple interfaces and multiple morphologies, and ensures the consistency of the solidified structure.

(2) The present invention utilizes the local forging effect of the ultrasonic impact process on the structure and the localized strengthening effect on the stress to regulate the stress in real time, control the stress distribution and transmission characteristics. In this way, the present invention ensures the evenness of the stress distribution.

(3) The present invention adopts follow-up ultrasound application, which has high utilization of ultrasound energy, and can implement effective ultrasound intervention on the DLD of a large space component.

### BRIEF DESCRIPTION OF DRAWINGS

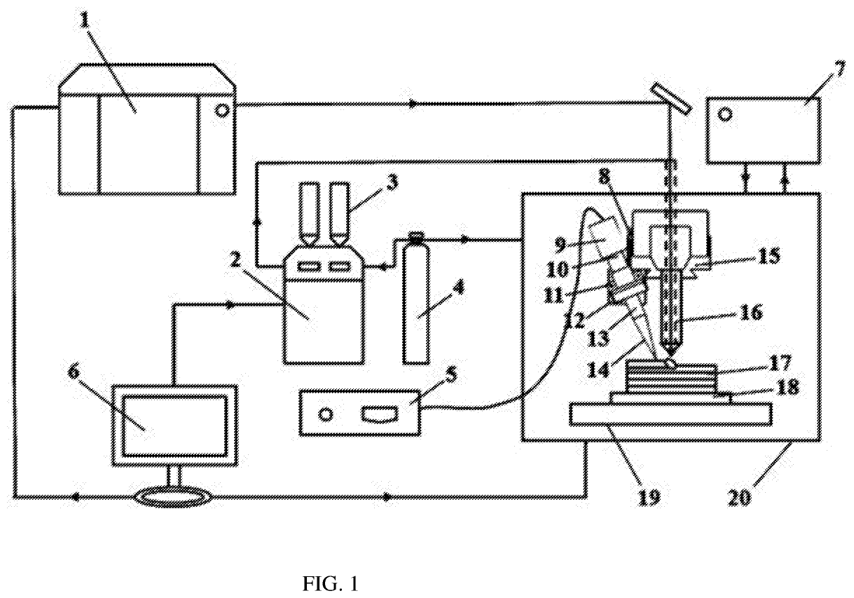

FIG. 1 is a schematic diagram of a device for forming a ceramic-reinforced MMC by follow-up ultrasonic-assisted DLD.
Reference Numerals: 1. laser; 2. powder feeder; 3. powder feeding cylinder; 4. protective gas system; 5. ultrasonic generator; 6. IPC; 7. cooling water circulation system; 8. F-shaped positioning base; 9. transducer; 10. horn; 11. ultrasonic impact gun holder; 12. T-shaped manual precision slide table; 13. tool head; 14. ultrasonic impact needle; 15. dovetail-shaped guide rail; 16. coaxial powder feeding nozzle; 17. deposited layer; 18. metal substrate; 19. computer numerical control (CNC) workbench; and 20. CNC machine tool.

### DETAILED DESCRIPTION

The specific implementations of the present invention are described in more detail below with reference to the accompanying drawings and technical solutions.

A device for forming a ceramic-reinforced metal matrix composite (MMC) by follow-up ultrasonic-assisted direct laser deposition (DLD), including a coaxial powder feeding type laser melt deposition (LMD) forming system, a positioning and clamping device and a follow-up ultrasound system.

The coaxial powder feeding type LMD forming system includes a laser 1, a powder feeder 2, a powder feeding cylinder 3, an industrial personal computer (IPC) 6, a coaxial powder feeding nozzle 16, a metal substrate 18, a computer numerical control (CNC) machine tool 20, a cooling water circulation system 7 and a protective gas system 4. The CNC machine tool 20 provided with a dovetail-shaped guide rail 15 and a computer numerical control (CNC) workbench 19. The metal substrate 18 is placed on an upper surface of the CNC workbench 19, and the metal plate 18 is a TC4 substrate. The coaxial powder feeding nozzle 16 is fixed on the dovetail-shaped guide rail 15. The laser 1 is provided with an optical path system. Laser light emitted by the laser 1 is emitted from the coaxial powder feeding nozzle 16 through the optical path system to form a laser beam on the metal substrate 18. Two powder feeding cylinders 3 are connected above the powder feeder 2 to provide a ceramic powder and a metal powder for the coaxial powder feeding type LMD forming system. The powder feeder 2 is connected to the coaxial powder feeding nozzle 16. A powder sprayed from the axial powder feeding nozzle 16 is converged on the metal substrate 18 and overlaps with the laser beam to form a deposited layer 17. The protective gas system (inert gas) 4 is connected to the powder feeder 2 on one side, and serves as a carrier gas to blow a cladding powder from the powder feeder 2 into a molten pool. The protective gas system 4 is connected to the coaxial powder feeding nozzle 16 on the other side, and serves as a coaxial protective gas. The cooling water circulation system 7 is connected to the coaxial powder feeding nozzle 16 for cooling a laser head on the coaxial powder feeding nozzle 16. The IPC 6 is connected to the laser 1, the powder feeder 2 and the CNC machine tool 20, and is used to control the laser 1, the powder feeder 2 and the CNC machine tool 20.

The positioning and clamping device includes an F-shaped positioning base 8, a T-shaped manual precision slide table 12 and an ultrasonic impact gun holder 11. The F-shaped positioning base 8 is fixed on one side of the dovetail-shaped guide rail 15. The T-shaped manual precision slide table 12 is fixed on the dovetail-shaped guide rail 8. The ultrasonic impact gun holder 11 is connected to the T-shaped manual precision slide table 12, and the ultrasonic impact gun holder 11 is used to fixedly connect the ultrasonic impact gun.

The follow-up ultrasound system includes an ultrasonic generator 5 and the ultrasonic impact gun connected to the ultrasonic generator 5. The ultrasonic impact gun includes a transducer 9, a horn 10, a tool head 13 and an ultrasonic impact needle 14 which are connected in order. The ultrasonic impact gun is fixed on the ultrasonic impact gun holder 11 and located directly behind the coaxial powder feeding nozzle 16, so that the ultrasonic impact gun follows the coaxial powder feeding nozzle 16.

Specifically, the protective gas system 4 is an inert gas.

The follow-up ultrasound system, the coaxial powder feeding type LMD forming system and the positioning and clamping device for keeping the ultrasonic impact gun to follow the coaxial powder feeding nozzle are used to perform DLD forming with TiC and TC4 powders, as follows:

(1) Grind the TC4 substrate with sandpaper, wipe with acetone, wash with deionized water, and finally dry the TC4 substrate: place the TiC and TC4 powders with a particle size of 25-45 μm in an electric forced air oven, and dry at 150° C. for 4 h; cool the TiC and TC4 powders, and then put the TC4 and TiC powders into the two powder feeding cylinders 3 of the powder feeder 2, respectively.

(2) Fix the F-shaped positioning base 8 on the Y-axis dovetail-shaped guide rail 15 of the CNC machine tool by a pressing force from a bolt; connect the F-shaped positioning base 8 to the T-shaped manual precision slide table 12, the T-shaped manual precision slide table 12 to the ultrasonic impact gun holder 11 and the ultrasonic impact gun holder 11 to the ultrasonic impact gun by a bolt and nut connection;

Adjust the angle between the axis of the ultrasonic impact gun and the axis of the coaxial powder feeding nozzle 16 to 30°; adjust the ultrasonic impact gun to directly behind the coaxial powder feeding nozzle 16, and keep a horizontal distance between the ultrasonic impact needle 14 and the coaxial powder feeding nozzle 16 at 7 mm, which falls within a maximum plastic deformation range of a cladding layer; adjust a vertical distance between the coaxial powder feeding nozzle 16 and the TC4 substrate to 9 mm, so that a powder convergence point of the coaxial powder feeding nozzle 16 is just on the TC4 substrate.

(3) Start the ultrasonic generator 5 so that the ultrasonic impact gun is in an ultrasonic vibration state, where the ultrasonic generator 5 has an ultrasonic power of 800 w and an ultrasonic frequency of 20 kHz.

(4) Start the cooling water circulation system 7, the laser 1, the protective gas system 4 and the powder feeder 2 in order, where the laser 1 has a laser power of 400 W and a scanning speed of 300 mm/min; a Z axis of the machine tool is lifted for 0.4 mm after each layer of deposition; the powder feeder 2 has a powder feed rate of 40 r/min.

(5) Start the CNC machine tool 20, and control the coaxial powder feeding nozzle to move relative to the TC4 substrate on the CNC workbench 19 to deposit a first layer of material, where at this time, the ultrasonic impact needle 14 acts 150 μm under a deposited layer 17, so as to ensure that the ultrasonic impact gun always acts on the deposited layer 17 to intervene in a melting process in real time and implement the regulation of a stress state, where each time a formed height is increased by 4 mm in a lifting direction of the Z axis, the ultrasonic power is increased by 140-160 W.

(6) Shut down the powder feeder 2, the protective gas system 4, the laser 1, the cooling water circulation system 7 and the CNC machine tool 20 in order after the formation is completed; gradually reduce the ultrasonic power of the ultrasonic generator 5 at the speed of 200 W/min to zero, and shut down the ultrasonic generator 5.

What is claimed is:

1. A device for forming a ceramic-reinforced metal matrix composite (MMC) by follow-up ultrasonic-assisted direct laser deposition (DLD), wherein the device comprises a coaxial powder feeding type laser melt deposition (LMD) forming system, a positioning and clamping device and a follow-up ultrasound system;
the coaxial powder feeding type LMD forming system comprises a laser (1), a powder feeder (2), a powder feeding cylinder (3), a coaxial powder feeding nozzle (16), a metal substrate (18), a computer numerical control (CNC) machine tool (20), a protective gas system (4), a cooling water circulation system (7) and an industrial personal computer (IPC) (6); the CNC machine tool (20) is provided with a dovetail-shaped guide rail (15) and a computer numerical control (CNC) workbench (19); the metal substrate (18) is placed on the CNC workbench (19); the coaxial powder feeding nozzle (16) is fixed on the dovetail-shaped guide rail (15); the laser (1) is provided with an optical path system; laser light emitted by the laser (1) is emitted from the coaxial powder feeding nozzle (16) through the optical path system to form a laser beam on the metal substrate (18); two powder feeding cylinders (3) are connected above the powder feeder (2) to provide a cladding powder; the powder feeder (2) is connected to the coaxial powder feeding nozzle (16); a powder sprayed from the axial powder feeding nozzle (16) is converged on the metal substrate (18) and overlaps with the laser beam to form a deposited layer (17); the protective gas system (4) is connected to the powder feeder (2) on one side to blow the cladding powder from the powder feeder (2) into a molten pool; the protective gas system (4) is connected to the coaxial powder feeding nozzle (16) on the other side and serves as a coaxial protective gas; the cooling water circulation system (7) is connected to the coaxial powder feeding nozzle (16) for cooling a laser head on the coaxial powder feeding nozzle (16); the IPC (6) is connected to the laser (1), the powder feeder (2) and the CNC machine tool (20), and is used to control the laser (1), the powder feeder (2) and the CNC machine tool (20);
the positioning and clamping device comprises an F-shaped positioning base (8), a T-shaped manual precision slide table (12) and an ultrasonic impact gun holder (11); the ultrasonic impact gun holder (11) is connected on the T-shaped manual precision slide table (12); the T-shaped manual precision slide table (12) is fixed on the F-shaped positioning base (8); the F-shaped positioning base (8) is fixed on the dovetail-shaped guide rail (15);
the follow-up ultrasound system comprises an ultrasonic generator (5) and an ultrasonic impact gun connected to the ultrasonic generator (5); the ultrasonic impact gun comprises a transducer (9), a horn (10), a tool head (13) and an ultrasonic impact needle (14) which are connected in order; the ultrasonic impact gun is fixed on the ultrasonic impact gun holder (11) and located directly behind the coaxial powder feeding nozzle (16), so that the ultrasonic impact gun follows the coaxial powder feeding nozzle (16).

2. The device for forming a ceramic-reinforced MMC by follow-up ultrasonic-assisted DLD according to claim 1, wherein an angle between an axis of the ultrasonic impact gun and an axis of the coaxial powder feeding nozzle (16) is 15°-45°; a vertical distance between the coaxial powder feeding nozzle (16) and the metal substrate (18) is 5-10 mm; a vertical distance between the ultrasonic impact needle (14) and the metal substrate (18) is 5-10 mm, and a horizontal distance between the ultrasonic impact needle (14) and the coaxial powder feeding nozzle (16) is 5-50 mm.

3. The device for forming a ceramic-reinforced MMC by follow-up ultrasonic-assisted DLD according to claim 1, wherein the metal substrate (18) is made of titanium, a titanium alloy, iron, an iron alloy, nickel, a nickel alloy, cobalt and a cobalt alloy.

4. The device for forming a ceramic-reinforced MMC by follow-up ultrasonic-assisted DLD according to claim 2, wherein the metal substrate (18) is made of titanium, a titanium alloy, iron, an iron alloy, nickel, a nickel alloy, cobalt and a cobalt alloy.

5. The device for forming a ceramic-reinforced MMC by follow-up ultrasonic-assisted DLD according to claim 1, wherein the protective gas system (4) is an inert gas.

6. The device for forming a ceramic-reinforced MMC by follow-up ultrasonic-assisted DLD according to claim 2, wherein the protective gas system (4) is an inert gas.

7. The device for forming a ceramic-reinforced MMC by follow-up ultrasonic-assisted DLD according to claim 3, wherein the protective gas system (4) is an inert gas.

8. The device for forming a ceramic-reinforced MMC by follow-up ultrasonic-assisted DLD according to claim 4, wherein the protective gas system (4) is an inert gas.

9. A method for implementing the device for forming a ceramic-reinforced MMC by follow-up ultrasonic-assisted DLD according to claim 1, specifically comprising the following steps:
(1) grinding, cleaning and drying the metal substrate (18); drying the cladding powder; putting the cladding powder into the two powder feeding cylinders (3) of the powder feeder (2), respectively;
(2) fixing the ultrasonic impact gun on the dovetail-shaped guide rail (15) through the positioning and clamping device, so that the ultrasonic impact gun follows the coaxial powder feeding nozzle (16); positioning the ultrasonic impact gun directly behind the coaxial powder feeding nozzle (16), keeping a horizontal distance between the ultrasonic impact needle (14) and the coaxial powder feeding nozzle (16) within a maximum plastic deformation range (5-50 mm) of a cladding layer, and adjusting a vertical distance between the coaxial powder feeding nozzle (16) and the metal substrate (18) to allow a powder convergence point of the coaxial powder feeding nozzle (16) on the metal substrate (18); adjusting a vertical distance between the ultrasonic impact gun and the metal substrate (18) to ensure that the ultrasonic impact needle (14) effectively acts on the deposited layer (17);
(3) starting the ultrasonic generator (5) so that the ultrasonic impact gun is in an ultrasonic vibration state, wherein the ultrasonic generator (5) has an ultrasonic power of 500-2000 w and an ultrasonic frequency of 15-25 kHz;
(4) starting the cooling water circulation system (7), the laser (1), the protective gas system (4) and the powder feeder (2) in order, wherein the laser (1) has a laser power of 200-2000 W and a scanning speed of 100-1000 mm/min; a Z axis of the machine tool is lifted for 0.1-1.0 mm after each layer of deposition; the powder feeder (2) has a powder feed rate of 10-50 r/min:
(5) starting the CNC machine tool (20), and controlling the coaxial powder feeding nozzle (16) to move relative to the metal substrate (18) on the CNC workbench (19) to deposit a first layer of material, wherein at this time, the ultrasonic impact needle (14) acts 50-250 μm under the deposited layer (17), so as to ensure that the ultrasonic impact gun always acts on the deposited layer (17) to intervene in a melting process in real time and implement the regulation of a stress state; each time a formed height is increased by 2-6 mm in a lifting direction of the Z axis, the ultrasonic power of the ultrasonic generator 5 is increased by 100-200 W; and
(6) shutting down the powder feeder (2), the protective gas system (4), the laser (1), the cooling water circulation system (7) and the CNC machine tool (20) in order after the formation is completed; gradually reducing the ultrasonic power of the ultrasonic generator (5) at the speed of 100-200 W/min to zero, and shutting down the ultrasonic generator (5).

10. A method for implementing the device for forming a ceramic-reinforced MMC by follow-up ultrasonic-assisted DLD according to claim 2, specifically comprising the following steps:
(1) grinding, cleaning and drying the metal substrate (18); drying the cladding powder; putting the cladding powder into the two powder feeding cylinders (3) of the powder feeder (2), respectively;
(2) fixing the ultrasonic impact gun on the dovetail-shaped guide rail (15) through the positioning and clamping device, so that the ultrasonic impact gun follows the coaxial powder feeding nozzle (16); positioning the ultrasonic impact gun directly behind the coaxial powder feeding nozzle (16), keeping a horizontal distance between the ultrasonic impact needle (14) and the coaxial powder feeding nozzle (16) within a maximum plastic deformation range (5-50 mm) of a cladding layer, and adjusting a vertical distance between the coaxial powder feeding nozzle (16) and the metal substrate (18) to allow a powder convergence point of the coaxial powder feeding nozzle (16) on the metal substrate (18); adjusting a vertical distance between the ultrasonic impact gun and the metal substrate (18) to ensure that the ultrasonic impact needle (14) effectively acts on the deposited layer (17);
(3) starting the ultrasonic generator (5) so that the ultrasonic impact gun is in an ultrasonic vibration state, wherein the ultrasonic generator (5) has an ultrasonic power of 500-2000 w and an ultrasonic frequency of 15-25 kHz;
(4) starting the cooling water circulation system (7), the laser (1), the protective gas system (4) and the powder feeder (2) in order, wherein the laser (1) has a laser power of 200-2000 W and a scanning speed of 100-1000 mm/min; a Z axis of the machine tool is lifted for 0.1-1.0 mm after each layer of deposition; the powder feeder (2) has a powder feed rate of 10-50 r/min:
(5) starting the CNC machine tool (20), and controlling the coaxial powder feeding nozzle (16) to move relative to the metal substrate (18) on the CNC workbench (19) to deposit a first layer of material, wherein at this time, the ultrasonic impact needle (14) acts 50-250 μm under the deposited layer (17), so as to ensure that the ultrasonic impact gun always acts on the deposited layer (17) to intervene in a melting process in real time and implement the regulation of a stress state; each time a formed height is increased by 2-6 mm in a lifting direction of the Z axis, the ultrasonic power of the ultrasonic generator 5 is increased by 100-200 W; and
(6) shutting down the powder feeder (2), the protective gas system (4), the laser (1), the cooling water circulation system (7) and the CNC machine tool (20) in order after the formation is completed; gradually reducing the ultrasonic power of the ultrasonic generator (5) at the speed of 100-200 W/min to zero, and shutting down the ultrasonic generator (5).

11. A method for implementing the device for forming a ceramic-reinforced MMC by follow-up ultrasonic-assisted DLD according to claim 3, specifically comprising the following steps:
(1) grinding, cleaning and drying the metal substrate (18); drying the cladding powder; putting the cladding powder into the two powder feeding cylinders (3) of the powder feeder (2), respectively;
(2) fixing the ultrasonic impact gun on the dovetail-shaped guide rail (15) through the positioning and clamping device, so that the ultrasonic impact gun follows the coaxial powder feeding nozzle (16); positioning the ultrasonic impact gun directly behind the coaxial powder feeding nozzle (16), keeping a horizontal distance between the ultrasonic impact needle (14) and the coaxial powder feeding nozzle (16) within a maximum plastic deformation range (5-50 mm) of a cladding layer, and adjusting a vertical distance between the coaxial powder feeding nozzle (16) and the metal substrate (18) to allow a powder convergence point of the coaxial powder feeding nozzle (16) on the metal substrate (18); adjusting a vertical distance between the ultrasonic impact gun and the metal substrate (18) to ensure that the ultrasonic impact needle (14) effectively acts on the deposited layer (17);
(3) starting the ultrasonic generator (5) so that the ultrasonic impact gun is in an ultrasonic vibration state, wherein the ultrasonic generator (5) has an ultrasonic power of 500-2000 w and an ultrasonic frequency of 15-25 kHz;
(4) starting the cooling water circulation system (7), the laser (1), the protective gas system (4) and the powder feeder (2) in order, wherein the laser (1) has a laser power of 200-2000 W and a scanning speed of 100-1000 mm/min; a Z axis of the machine tool is lifted for 0.1-1.0 mm after each layer of deposition; the powder feeder (2) has a powder feed rate of 10-50 r/min:
(5) starting the CNC machine tool (20), and controlling the coaxial powder feeding nozzle (16) to move relative to the metal substrate (18) on the CNC workbench (19) to deposit a first layer of material, wherein at this time, the ultrasonic impact needle (14) acts 50-250 μm under the deposited layer (17), so as to ensure that the ultrasonic impact gun always acts on the deposited layer (17) to intervene in a melting process in real time and implement the regulation of a stress state; each time a formed height is increased by 2-6 mm in a lifting direction of the Z axis, the ultrasonic power of the ultrasonic generator 5 is increased by 100-200 W; and
(6) shutting down the powder feeder (2), the protective gas system (4), the laser (1), the cooling water circulation system (7) and the CNC machine tool (20) in order after the formation is completed; gradually reducing the ultrasonic power of the ultrasonic generator (5) at the speed of 100-200 W/min to zero, and shutting down the ultrasonic generator (5).

12. A method for implementing the device for forming a ceramic-reinforced MMC by follow-up ultrasonic-assisted DLD according to claim 4, specifically comprising the following steps:
(1) grinding, cleaning and drying the metal substrate (18); drying the cladding powder; putting the cladding powder into the two powder feeding cylinders (3) of the powder feeder (2), respectively;
(2) fixing the ultrasonic impact gun on the dovetail-shaped guide rail (15) through the positioning and clamping device, so that the ultrasonic impact gun follows the coaxial powder feeding nozzle (16); positioning the ultrasonic impact gun directly behind the coaxial powder feeding nozzle (16), keeping a horizontal distance between the ultrasonic impact needle (14) and the coaxial powder feeding nozzle (16) within a maximum plastic deformation range (5-50 mm) of a cladding layer, and adjusting a vertical distance between the coaxial powder feeding nozzle (16) and the metal substrate (18) to allow a powder convergence point of the coaxial powder feeding nozzle (16) on the metal substrate (18); adjusting a vertical distance between the ultrasonic impact gun and the metal substrate (18) to ensure that the ultrasonic impact needle (14) effectively acts on the deposited layer (17);
(3) starting the ultrasonic generator (5) so that the ultrasonic impact gun is in an ultrasonic vibration state, wherein the ultrasonic generator (5) has an ultrasonic power of 500-2000 w and an ultrasonic frequency of 15-25 kHz;
(4) starting the cooling water circulation system (7), the laser (1), the protective gas system (4) and the powder feeder (2) in order, wherein the laser (1) has a laser power of 200-2000 W and a scanning speed of 100-1000 mm/min; a Z axis of the machine tool is lifted for 0.1-1.0 mm after each layer of deposition; the powder feeder (2) has a powder feed rate of 10-50 r/min:
(5) starting the CNC machine tool (20), and controlling the coaxial powder feeding nozzle (16) to move relative to the metal substrate (18) on the CNC workbench (19) to deposit a first layer of material, wherein at this time, the ultrasonic impact needle (14) acts 50-250 μm under the deposited layer (17), so as to ensure that the ultrasonic impact gun always acts on the deposited layer (17) to intervene in a melting process in real time and implement the regulation of a stress state; each time a formed height is increased by 2-6 mm in a lifting direction of the Z axis, the ultrasonic power of the ultrasonic generator 5 is increased by 100-200 W; and
(6) shutting down the powder feeder (2), the protective gas system (4), the laser (1), the cooling water circulation system (7) and the CNC machine tool (20) in order after the formation is completed; gradually reducing the ultrasonic power of the ultrasonic generator (5) at the speed of 100-200 W/min to zero, and shutting down the ultrasonic generator (5).

13. A method for implementing the device for forming a ceramic-reinforced MMC by follow-up ultrasonic-assisted DLD according to claim 5, specifically comprising the following steps:
(1) grinding, cleaning and drying the metal substrate (18); drying the cladding powder; putting the cladding powder into the two powder feeding cylinders (3) of the powder feeder (2), respectively;
(2) fixing the ultrasonic impact gun on the dovetail-shaped guide rail (15) through the positioning and clamping device, so that the ultrasonic impact gun follows the coaxial powder feeding nozzle (16); positioning the ultrasonic impact gun directly behind the coaxial powder feeding nozzle (16), keeping a horizontal distance between the ultrasonic impact needle (14) and the coaxial powder feeding nozzle (16) within a maximum plastic deformation range (5-50 mm) of a cladding layer, and adjusting a vertical distance between the coaxial powder feeding nozzle (16) and the metal substrate (18) to allow a powder convergence point of the coaxial powder feeding nozzle (16) on the metal substrate (18); adjusting a vertical distance between the ultrasonic impact gun and the metal substrate (18) to ensure that the ultrasonic impact needle (14) effectively acts on the deposited layer (17);
(3) starting the ultrasonic generator (5) so that the ultrasonic impact gun is in an ultrasonic vibration state, wherein the ultrasonic generator (5) has an ultrasonic power of 500-2000 w and an ultrasonic frequency of 15-25 kHz;
(4) starting the cooling water circulation system (7), the laser (1), the protective gas system (4) and the powder feeder (2) in order, wherein the laser (1) has a laser power of 200-2000 W and a scanning speed of 100-1000 mm/min; a Z axis of the machine tool is lifted for 0.1-1.0 mm after each layer of deposition; the powder feeder (2) has a powder feed rate of 10-50 r/min:
(5) starting the CNC machine tool (20), and controlling the coaxial powder feeding nozzle (16) to move relative to the metal substrate (18) on the CNC workbench (19) to deposit a first layer of material, wherein at this time, the ultrasonic impact needle (14) acts 50-250 μm under the deposited layer (17), so as to ensure that the ultrasonic impact gun always acts on the deposited layer (17) to intervene in a melting process in real time and implement the regulation of a stress state; each time a formed height is increased by 2-6 mm in a lifting direction of the Z axis, the ultrasonic power of the ultrasonic generator 5 is increased by 100-200 W; and
(6) shutting down the powder feeder (2), the protective gas system (4), the laser (1), the cooling water circulation system (7) and the CNC machine tool (20) in order after the formation is completed; gradually reducing the ultrasonic power of the ultrasonic generator (5) at the speed of 100-200 W/min to zero, and shutting down the ultrasonic generator (5).

14. A method for implementing the device for forming a ceramic-reinforced MMC by follow-up ultrasonic-assisted DLD according to claim 6, specifically comprising the following steps:
(1) grinding, cleaning and drying the metal substrate (18); drying the cladding powder; putting the cladding powder into the two powder feeding cylinders (3) of the powder feeder (2), respectively;
(2) fixing the ultrasonic impact gun on the dovetail-shaped guide rail (15) through the positioning and clamping device, so that the ultrasonic impact gun follows the coaxial powder feeding nozzle (16); positioning the ultrasonic impact gun directly behind the coaxial powder feeding nozzle (16), keeping a horizontal distance between the ultrasonic impact needle (14) and the coaxial powder feeding nozzle (16) within a maximum plastic deformation range (5-50 mm) of a cladding layer, and adjusting a vertical distance between the coaxial powder feeding nozzle (16) and the metal substrate (18) to allow a powder convergence point of the coaxial powder feeding nozzle (16) on the metal substrate (18); adjusting a vertical distance between the ultrasonic impact gun and the metal substrate (18) to ensure that the ultrasonic impact needle (14) effectively acts on the deposited layer (17);
(3) starting the ultrasonic generator (5) so that the ultrasonic impact gun is in an ultrasonic vibration state, wherein the ultrasonic generator (5) has an ultrasonic power of 500-2000 w and an ultrasonic frequency of 15-25 kHz;
(4) starting the cooling water circulation system (7), the laser (1), the protective gas system (4) and the powder feeder (2) in order, wherein the laser (1) has a laser power of 200-2000 W and a scanning speed of 100-1000 mm/min; a Z axis of the machine tool is lifted for 0.1-1.0 mm after each layer of deposition; the powder feeder (2) has a powder feed rate of 10-50 r/min:
(5) starting the CNC machine tool (20), and controlling the coaxial powder feeding nozzle (16) to move relative to the metal substrate (18) on the CNC workbench (19) to deposit a first layer of material, wherein at this time, the ultrasonic impact needle (14) acts 50-250 μm under the deposited layer (17), so as to ensure that the ultrasonic impact gun always acts on the deposited layer (17) to intervene in a melting process in real time and implement the regulation of a stress state; each time a formed height is increased by 2-6 mm in a lifting direction of the Z axis, the ultrasonic power of the ultrasonic generator 5 is increased by 100-200 W; and
(6) shutting down the powder feeder (2), the protective gas system (4), the laser (1), the cooling water circulation system (7) and the CNC machine tool (20) in order after the formation is completed; gradually reducing the ultrasonic power of the ultrasonic generator (5) at the speed of 100-200 W/min to zero, and shutting down the ultrasonic generator (5).

15. A method for implementing the device for forming a ceramic-reinforced MMC by follow-up ultrasonic-assisted DLD according to claim 7, specifically comprising the following steps:
(1) grinding, cleaning and drying the metal substrate (18); drying the cladding powder; putting the cladding powder into the two powder feeding cylinders (3) of the powder feeder (2), respectively;
(2) fixing the ultrasonic impact gun on the dovetail-shaped guide rail (15) through the positioning and clamping device, so that the ultrasonic impact gun follows the coaxial powder feeding nozzle (16); positioning the ultrasonic impact gun directly behind the coaxial powder feeding nozzle (16), keeping a horizontal distance between the ultrasonic impact needle (14) and the coaxial powder feeding nozzle (16) within a maximum plastic deformation range (5-50 mm) of a cladding layer, and adjusting a vertical distance between the coaxial powder feeding nozzle (16) and the metal substrate (18) to allow a powder convergence point of the coaxial powder feeding nozzle (16) on the metal substrate (18); adjusting a vertical distance between the ultrasonic impact gun and the metal substrate (18) to ensure that the ultrasonic impact needle (14) effectively acts on the deposited layer (17);
(3) starting the ultrasonic generator (5) so that the ultrasonic impact gun is in an ultrasonic vibration state, wherein the ultrasonic generator (5) has an ultrasonic power of 500-2000 w and an ultrasonic frequency of 15-25 kHz;
(4) starting the cooling water circulation system (7), the laser (1), the protective gas system (4) and the powder feeder (2) in order, wherein the laser (1) has a laser power of 200-2000 W and a scanning speed of 100-1000 mm/min; a Z axis of the machine tool is lifted for 0.1-1.0 mm after each layer of deposition; the powder feeder (2) has a powder feed rate of 10-50 r/min:
(5) starting the CNC machine tool (20), and controlling the coaxial powder feeding nozzle (16) to move relative to the metal substrate (18) on the CNC workbench (19) to deposit a first layer of material, wherein at this time, the ultrasonic impact needle (14) acts 50-250 μm under the deposited layer (17), so as to ensure that the ultrasonic impact gun always acts on the deposited layer (17) to intervene in a melting process in real time and implement the regulation of a stress state; each time a formed height is increased by 2-6 mm in a lifting direction of the Z axis, the ultrasonic power of the ultrasonic generator 5 is increased by 100-200 W; and
(6) shutting down the powder feeder (2), the protective gas system (4), the laser (1), the cooling water circulation system (7) and the CNC machine tool (20) in order after the formation is completed; gradually reducing the ultrasonic power of the ultrasonic generator (5) at the speed of 100-200 W/min to zero, and shutting down the ultrasonic generator (5).

16. A method for implementing the device for forming a ceramic-reinforced MMC by follow-up ultrasonic-assisted DLD according to claim 8, specifically comprising the following steps:
(1) grinding, cleaning and drying the metal substrate (18); drying the cladding powder; putting the cladding powder into the two powder feeding cylinders (3) of the powder feeder (2), respectively;
(2) fixing the ultrasonic impact gun on the dovetail-shaped guide rail (15) through the positioning and clamping device, so that the ultrasonic impact gun follows the coaxial powder feeding nozzle (16); positioning the ultrasonic impact gun directly behind the coaxial powder feeding nozzle (16), keeping a horizontal distance between the ultrasonic impact needle (14) and the coaxial powder feeding nozzle (16) within a maximum plastic deformation range (5-50 mm) of a cladding layer, and adjusting a vertical distance between the coaxial powder feeding nozzle (16) and the metal substrate (18) to allow a powder convergence point of the coaxial powder feeding nozzle (16) on the metal substrate (18); adjusting a vertical distance between the ultrasonic impact gun and the metal substrate (18) to ensure that the ultrasonic impact needle (14) effectively acts on the deposited layer (17);
(3) starting the ultrasonic generator (5) so that the ultrasonic impact gun is in an ultrasonic vibration state, wherein the ultrasonic generator (5) has an ultrasonic power of 500-2000 w and an ultrasonic frequency of 15-25 kHz;
(4) starting the cooling water circulation system (7), the laser (1), the protective gas system (4) and the powder feeder (2) in order, wherein the laser (1) has a laser power of 200-2000 W and a scanning speed of 100-1000 mm/min; a Z axis of the machine tool is lifted for 0.1-1.0 mm after each layer of deposition; the powder feeder (2) has a powder feed rate of 10-50 r/min:
(5) starting the CNC machine tool (20), and controlling the coaxial powder feeding nozzle (16) to move relative to the metal substrate (18) on the CNC workbench (19) to deposit a first layer of material, wherein at this time, the ultrasonic impact needle (14) acts 50-250 μm under the deposited layer (17), so as to ensure that the ultrasonic impact gun always acts on the deposited layer (17) to intervene in a melting process in real time and implement the regulation of a stress state; each time a formed height is increased by 2-6 mm in a lifting direction of the Z axis, the ultrasonic power of the ultrasonic generator 5 is increased by 100-200 W; and
(6) shutting down the powder feeder (2), the protective gas system (4), the laser (1), the cooling water circulation system (7) and the CNC machine tool (20) in order after the formation is completed; gradually reducing the ultrasonic power of the ultrasonic generator (5) at the speed of 100-200 W/min to zero, and shutting down the ultrasonic generator (5).

17. The method for forming a ceramic-reinforced MMC by follow-up ultrasonic-assisted DLD according to claim 9, wherein in step (1), the cladding powder comprises a ceramic powder and a metal powder; the ceramic powder comprises a carbide, an oxide, a boride and a nitride; the metal powder comprises titanium, a titanium alloy, iron, an iron alloy, nickel, a nickel alloy, cobalt and a cobalt alloy.

18. The method for forming a ceramic-reinforced MMC by follow-up ultrasonic-assisted DLD according to claim 10, wherein in step (1), the cladding powder comprises a ceramic powder and a metal powder; the ceramic powder comprises a carbide, an oxide, a boride and a nitride; the metal powder comprises titanium, a titanium alloy, iron, an iron alloy, nickel, a nickel alloy, cobalt and a cobalt alloy.

19. The method for forming a ceramic-reinforced MMC by follow-up ultrasonic-assisted DLD according to claim 9, wherein in step (1), the process of drying the cladding powder is as follows:
drying the cladding powder at 100-150° C. for 4-6 h, and then naturally cooling.

20. The method for forming a ceramic-reinforced MMC by follow-up ultrasonic-assisted DLD according to claim 17, wherein in step (1), the process of drying the cladding powder is as follows:
drying the cladding powder at 100-150° C. for 4-6 h, and then naturally cooling.
